(19) United States
(12) Patent Application Publication
(10) Pub. No.: US 2013/0287659 A1
(43) Pub. Date: Oct. 31, 2013

(54) COMBINED HYDROCARBON TRAP AND CATALYST

(71) Applicants: Jason Aaron Lupescu, Ypsilanti, MI (US); Hungwen Jen, Troy, MI (US)

(72) Inventors: Jason Aaron Lupescu, Ypsilanti, MI (US); Hungwen Jen, Troy, MI (US)

(73) Assignee: FORD GLOBAL TECHNOLOGIES, LLC, Dearborn, MI (US)

(21) Appl. No.: 13/569,476

(22) Filed: Aug. 8, 2012

Related U.S. Application Data
(60) Provisional application No. 61/638,862, filed on Apr. 26, 2012.

(51) Int. Cl. B01J 29/04; B01J 29/072; B01D 53/94

(52) U.S. Cl. 423/213.5; 422/180; 502/74

(57) ABSTRACT

A combined hydrocarbon trap/oxidation catalyst system is provided for reducing cold-start hydrocarbon emissions. The hydrocarbon trap includes a monolithic substrate containing zeolite and a catalyst including a mixture of nickel and copper which is impregnated into or washcoated onto the substrate. The hydrocarbon trap may be positioned in the exhaust gas passage of a vehicle such that hydrocarbons are adsorbed on the trap and stored until the engine and exhaust reach a sufficient temperature for desorption and oxidation of the hydrocarbons.

### CROSS REFERENCE TO RELATED APPLICATIONS

This application claims the benefit of U.S. Provisional Patent Application Ser. No. 61/638,862, entitled Cu+Ni Impregnated Zeolite for Improved HC Retention Performance and Similar Oxidation Performance to HC traps catalyzed with costly Pt, Pd and Rh Metals, filed Apr. 26, 2012. The entire contents of said application is hereby incorporated by reference.

### BACKGROUND OF THE INVENTION

Embodiments described herein relate to a hydrocarbon trap which can be used in combination with an oxidation catalyst, where the trap provides improved hydrocarbon retention of cold-start engine emissions and oxidation of such emissions when the catalyst reaches its light-off temperature. More particularly, embodiments described herein relate to a hydrocarbon trap utilizing a catalyst comprising a mixture of copper and nickel on a monolith substrate.

In recent years, considerable efforts have been made to reduce the level of hydrocarbon (HC) emissions from vehicle engines. Conventional exhaust treatment catalysts such as three-way catalysts achieve oxidation of hydrocarbons to CO₂ and water and help prevent the exit of unburnt or partially burnt hydrocarbon emissions from a vehicle. However, these emissions are high during cold starting of the engine before the latent heat of the exhaust gas allows the catalyst to become active, i.e., before the catalyst has reached its “light-off” temperature.

Hydrocarbon traps have been developed for reducing emissions during cold-starting by trapping/adsorbing hydrocarbon (HC) emissions at low temperatures and releasing/desorbing them from the trap at sufficiently elevated temperatures for oxidation over a catalyst. Such catalysts are typically three-way catalysts comprising a precious metal such as platinum, palladium or rhodium. Currently, zeolites have been the most widely used adsorption materials for hydrocarbon traps. The zeolites are typically combined with the three-way catalyst and washcoated onto a monolith substrate. However, the use of three-way catalysts comprising precious metals is relatively expensive.

In addition, even with the use of a hydrocarbon trap, stored HC can still desorb before the three-way catalyst is active, and this problem increases with the aging of the trap. For example, high temperature aging during vehicle operation causes stored HC to desorb at lower temperatures from the zeolite and requires higher temperatures to achieve oxidation of the released HC. While lower oxidation temperatures have been achieved by placing the zeolite HC trap in the underbody converter assembly of the vehicle, exhaust gas oxygen required to enable conversion of trapped HC to CO₂ and water is limited in this location as control of oxygen is monitored only across the upstream converter assembly.

It would be desirable to improve the overall hydrocarbon trap function by improving the retention of HC species during cold starting and achieving oxidation of the stored HC emissions with a reduction in the use of expensive precious metals in the catalyst.

### SUMMARY OF THE INVENTION

Embodiments of the invention provide a combined hydrocarbon trap and catalyst system which utilizes a monolithic substrate containing zeolite and including a catalyst comprising a mixture of copper and nickel metals to store and oxidize hydrocarbon emissions. The hydrocarbon trap may optionally further include a three-way catalyst which utilizes reduced amounts of precious metals because of the oxidation of hydrocarbons which is achieved using the nickel-copper catalyst in the system.

According to one aspect of the invention, a combined hydrocarbon trap and catalyst system for reducing cold-start vehicle exhaust emissions is provided which comprises a monolithic substrate containing zeolite and a catalyst comprising a mixture of copper (Cu) and nickel (Ni) impregnated in or washcoated on the substrate. In one embodiment, the monolithic substrate comprises an extruded zeolite substrate. In another embodiment, the monolithic substrate comprises a ceramic substrate which has been washcoated with zeolite.

The Cu—Ni mixture is preferably used in a ratio of 50% by weight Cu and 50% by weight Ni, and the mixture preferably comprises from about 1 to 20 wt % of the total weight of the monolithic substrate, and more preferably, from about 6 to 7 wt %.

The zeolite preferably has a Si/Al₂ ratio of about 20 to 100. The zeolite may comprise beta-zeolite or a metal-containing zeolite, such as Fe-ion exchanged beta-zeolite. The hydrocarbon trap may have a zeolite content of about 2 to 8 g/in³. In one embodiment, the hydrocarbon trap has a zeolite content of from about 4 g/in³ to about 5 g/in³.

The combined hydrocarbon trap and catalyst system may optionally further include a three-way catalyst selected from platinum, palladium, rhodium, and combinations thereof. The three-way catalyst is preferably included at a loading of about 0.1 g/in³ to about 3.0 g/in³.

According to another aspect of the invention, a method for reducing cold start hydrocarbon emissions is provided in which the combined hydrocarbon trap and catalyst system is positioned in the exhaust passage of a vehicle. As exhaust gases are passed through the exhaust passage, the hydrocarbon trap adsorbs hydrocarbon emissions and retains the hydrocarbons until sufficient temperatures are reached for catalytic conversion by the nickel and copper mixture, i.e., from about 200° C. to about 600° C.

Accordingly, it is a feature of embodiments of the invention to provide a combined hydrocarbon trap and catalyst system for reducing cold start vehicle exhaust emissions and for achieving oxidation of such emissions. Other features and advantages of the invention will be apparent from the following description, the accompanying drawings, and the appended claims.

### BRIEF DESCRIPTION OF THE DRAWINGS

FIGS. 1A and 1B are cross-sectional views of a combined hydrocarbon trap/catalyst system in accordance with embodiments of the invention; and

FIG. 2 is a schematic illustration of an exhaust treatment system including a combined hydrocarbon trap/catalyst system in accordance with an embodiment of the invention;

FIG. 3 is a graph illustrating hydrocarbon desorption with the combined hydrocarbon trap/catalyst system in comparison with traps which do not contain a Cu—Ni catalyst; and

FIG. 4 is a graph illustrating hydrocarbon conversion efficiency of the hydrocarbon trap/catalyst system in comparison with traps which do not contain the Cu—Ni catalyst;

FIG. 5 is a graph illustrating temperatures (° C.) at which 80% of stored hydrocarbons are released in hydrocarbon traps containing zeolites having different Si/Al₂ ratios;

FIG. 6 is a graph illustrating temperatures (° C.) at which 80% of stored hydrocarbons are released in hydrocarbon traps containing different ratios of Cu:Ni for fresh and aged (50 hr) traps;

FIG. 7 is a graph illustrating adsorbed HC conversion efficiency of hydrocarbon traps containing different ratios of Cu:Ni for fresh and aged (50 hr) traps; and

FIG. 8 is a graph illustrating the effect of Cu loading on the hydrocarbon trap with regard to propylene desorption for temperatures up to 600° C.

### DETAILED DESCRIPTION OF THE PREFERRED EMBODIMENTS

Embodiments of the combined hydrocarbon trap and catalyst system described herein utilize a mixture of nickel (Ni) and copper (Cu) metals added to a monolithic substrate containing zeolite. We have found that the addition of the Cu—Ni mixture provides effective oxidation of hydrocarbons such as ethanol, toluene and propylene. In addition, we have found that use of the Cu—Ni mixture provides a 100° C. improvement in hydrocarbon retention of olefin and aromatic hydrocarbon species in comparison with identical extruded zeolite monoliths which do not contain such a mixture, i.e., HC species are retained/adsorbed on the substrate at temperatures 100° C. higher than zeolite traps without such a mixture and do not prematurely desorb before catalyst light-off temperature is achieved.

We have also found that use of the Cu—Ni mixture facilitates the oxidation of coke (i.e., residual stored HC species that remain after desorption at 600° C.) at lower temperatures (at least 50° C. lower) in comparison with an identical hydrocarbon trap which does not contain the Cu—Ni catalyst mixture. The use of the Cu—Ni catalyst mixture also reduces the amount of platinum, palladium and rhodium metals needed for the three-way catalyst while still providing effective oxidation of hydrocarbon species in comparison with a zeolite monolith containing higher amounts of such metals. The efficient hydrocarbon retention and oxidation is also retained as the trap/catalyst system ages.

While not wishing to be bound by theory, it is believed that the mixture of copper and nickel provides a synergistic effect in that it exhibits better redox/water-gas-shift (WGS) activity than the use of nickel or copper alone, resulting in increased CO conversion.

Unless otherwise indicated, the disclosure of any ranges in the specification and claims are to be understood as including the range itself and also anything subsumed therein, as well as endpoints.

Preferred zeolite materials for use in the hydrocarbon trap include beta-zeolite or Fe-ion exchanged beta-zeolite. Other suitable zeolite materials include Cu-ion exchanged beta-zeolite. The zeolite substrate preferably has a Si/Al₂ ratio of from about 20 to 100.

The monolithic substrate may comprise a washcoated ceramic substrate such as cordierite or an extruded zeolite substrate. Where the zeolite substrate is formed by extrusion, the zeolite material and a binder is preferably extruded in the form of a slurry containing from about 60 to 80% by weight zeolite through an extrusion die which is configured so as to produce a monolith having an open frontal area (OFA) of about 40 to 60%. By “open frontal area,” it is meant it is meant the part of the total substrate cross-sectional area which is available for the flow of gas. The OFA is expressed as a percentage of the total substrate cross-section or substrate void fraction.

The resulting zeolite monolith has a cell density of between about 200 and 400 cpsi, and more preferably, 400 cpsi, and a wall thickness of about 10 to 25 mil. The zeolite content of the substrate is from about 60 to 80% by weight.

Where the zeolite is washcoated onto a ceramic substrate such as cordierite, the washcoat includes a slurry containing about 50 to 90% by weight of the desired zeolite and about 10 to 50% by weight of other chemicals including the binder materials for washcoat adhesion. Where a cordierite ceramic monolith is used, the monolith should have an open frontal area of about 70% to 90%. The monolith may have a square or hexagonal cell density, and more preferably, a hexagonal cell density to provide a uniform coating to minimize washcoat accumulation in the corners. The resulting washcoated monolith should exhibit a cell density of between about 200 and 600 cpsi and a wall thickness of about 20 to 10 mil.

The ratio of the Cu:Ni mixture may vary from 25:75 to 75:25, but is preferably used in a ratio of 50% by weight Cu and 50% by weight Ni. While not wishing to be bound by theory, it is believed that copper provides good adsorption of propylene and toluene, while nickel helps to stabilize the copper during aging and provide sintering resistance to the copper. Copper alone is not effective as it severely damages the substrate during aging and provides poor performance with aging. Nickel is also ineffective by itself. The range of mixtures provides a good balance between sintering resistance, HC oxidation activity, and high temperature HC storage.

The Cu—Ni mixture is preferably present in or on the monolithic substrate at about 3 wt % Cu and about 3 wt % nickel (6 wt % total), or about 3.5 wt % Cu and about 3.5 wt % nickel (7 wt % total) based on the total weight of the monolith substrate. Ideally, the copper and nickel should each be present in an amount of at least between about 1% and 3.5% to prevent desorption of hydrocarbons below 200° C.

The Cu—Ni mixture is preferably incorporated into the substrate by wet impregnation (as nickel and copper nitrate salts) and may be added to the zeolite slurry prior to extrusion or washcoating.

Where a three-way catalyst is included in the hydrocarbon trap, it is preferably applied as an individual washcoat layer onto the monolithic substrate. Alternatively, the three-way catalyst may be combined with the zeolite slurry prior to extrusion or washcoating.

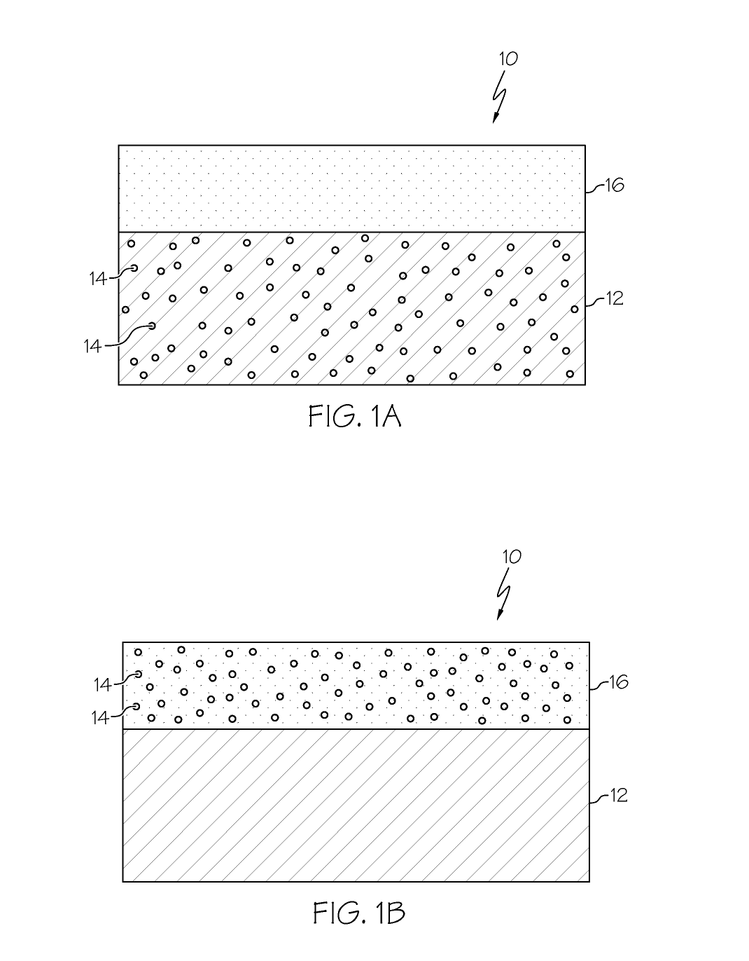

Referring now to FIG. 1A, an embodiment of the combined hydrocarbon trap/oxidation catalyst 10 is illustrated. As shown, the trap 10 includes a monolithic substrate 12 containing zeolite and including a Cu—Ni mixture 14 impregnated in the monolithic substrate, and, optionally, a separate layer of a three-way catalyst material 16 on the zeolite substrate. FIG. 1B illustrates an embodiment in which the trap 10 comprises a ceramic substrate 20 containing a washcoat of the Cu—Ni mixture 14 and a three-way catalyst material 16.

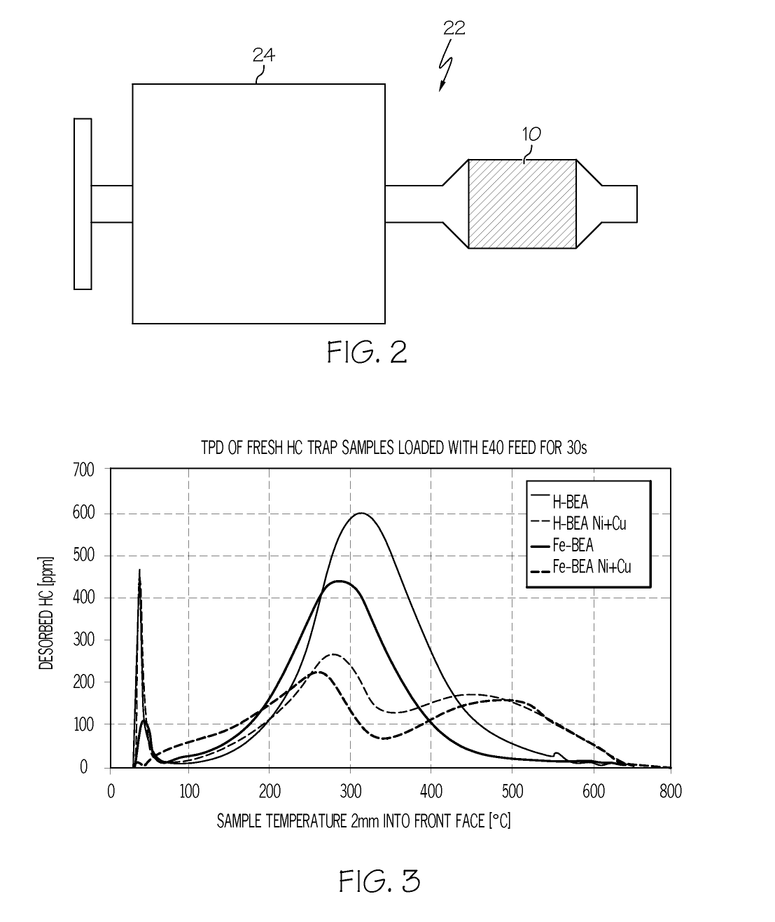

Referring now to FIG. 2, an exhaust treatment system 22 includes a hydrocarbon trap/catalyst 10 in an underbody location of a vehicle (not shown). As shown, the exhaust treatment system is coupled to an exhaust manifold 24 of an engine. The system may include additional catalysts or filters (not shown) in addition to the hydrocarbon trap.

During operation, as exhaust gas generated by the engine passes through the hydrocarbon trap/catalyst system 10, the cold-start emissions of ethanol and other small molecules of hydrocarbons such as propylene and ethylene are adsorbed and stored in the trap while the engine/catalyst is cold. The hydrocarbons and ethanol are retained in the trap until the engine and the exhaust therefrom reach sufficiently elevated temperatures to heat the trap and cause desorption, i.e., reach a trap temperature of from about 200° C. to 400° C. The hydrocarbons are then converted to CO or CO₂ by the Cu—Ni oxidation catalyst and optional three-way catalyst materials in or on the trap.

In order that the invention may be more readily understood, reference is made to the following examples, which are intended to illustrate the invention, but are not to be taken as limiting the scope thereof.

### Example 1

Two hydrocarbon traps were prepared in accordance with an embodiment of the invention. The first trap comprised an extruded zeolite monolith formed by extruding 80% by weight H-Beta-40 (H-BEA) zeolite through an extruder at a cell density of 400 cpsi and a wall thickness of 14 mil. The resulting zeolite content was 5.4 g/in³. A second trap comprised an extruded zeolite monolith formed by extruding 65% by weight Fe-ion exchanged zeolite through an extruder at a cell density of 400 cpsi and a wall thickness of 11 mil. The resulting zeolite content was 3.9 g/in.³ Both traps were impregnated with 7 wt % of a Cu—Ni mixture.

For purposes of comparison, two extruded zeolite-traps identical to the traps above were prepared without the Cu—Ni mixture. FIG. 3 illustrates the desorption temperature achieved with the traps containing a Cu—Ni catalyst in comparison with the traps which contained no Cu—Ni. The samples were evaluated in an inert feed gas containing 10% H₂O and the balance N₂ at a gas space velocity of 30,000/hr.

The testing conditions included preconditioning of the samples at 650° C. in 2% oxygen and nitrogen, followed by a 5-minute reduction in 0.2% CO, 0.08% H₂ in nitrogen, followed by a cooldown to 30° C. in nitrogen. In order to simulate gasoline cold start emissions, each sample was exposed to a loading (E40 feed) of 0.18% HC species (5% acetaldehyde, 27% ethanol, 40% propylene, 16% isopentane, and 12% toluene), 0.2% CO, 0.8% H₂, and 10% water vapor in air at 30,000/hr and 30° C. for 30 seconds. After 30 seconds, the HC was removed from the feed stream and the carrier gas was switched from oxygen to nitrogen.

In addition, the following feed conditions were used during temperature programmed desorption (TPD):

Inert TPD (lambda=1.000) 10% water vapor in nitrogen

Stoichiometric TPD (lambda=1.007) 500 ppm CO, 188 ppm H₂, 700 ppm O₂, 10% water vapor in nitrogen

The feed was reintroduced to the samples and the sample oven was triggered to ramp from 30° C. to 600° C. at 100° C./min. The adsorbed HC converted is the amount of stored HC not detected by the FID analyzer to desorb from the sample by 600° C. since the FID analyzer does not detect CO or CO₂ (integrated HC desorption area/integrated adsorption area). As can be seen, more hydrocarbons were retained in the trap and then desorbed at higher temperatures with the hydrocarbon traps containing Cu—Ni catalyst in comparison with those which did not contain Cu—Ni.

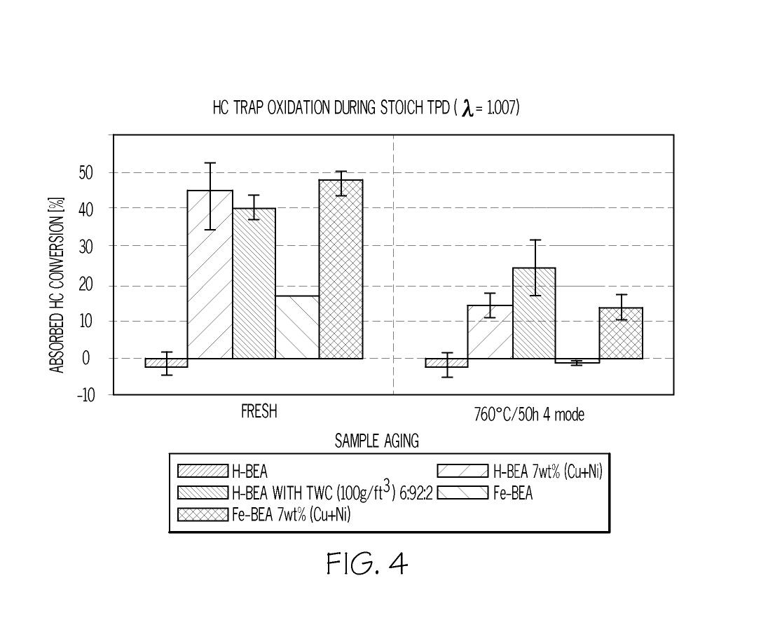

The samples above were further evaluated for HC conversion efficiency along with an additional sample comprising an extruded H-Beta-40 zeolite with a TWC overlayer loaded at 100 g/ft³ (Pt:Pd:Rh). The samples were evaluated in a stoichiometric feed, each at a gas space velocity of 30,000 hr. The results are shown in FIG. 4. As shown, the extruded H-beta zeolite (without Cu—Ni) did not show measurable oxidation of stored HC either in the fresh state or after full useful life aging. The extruded Fe-Beta zeolite (without Cu—Ni) did show 17% oxidation of stored HC in the fresh state, but not measurable oxidation of stored HC after full useful life aging. As can be seen, adding a Cu—Ni catalyst to the extruded Beta zeolite samples (H— and Fe—) improved oxidation of stored HC to about the same level of 45% fresh and 14% aged. The extruded H-Beta zeolite with a TWC overlayer loaded at 100 g/ft³ (Pt:Pd:Rh) showed oxidation of stored HC to 40% fresh, then outperformed the traps with a Cu—Ni catalyst after aging with oxidation of stored HC at 24%. It can be concluded from these results that the Cu—Ni catalyst should be used in conjunction with a TWC overlayer, but should enable a precious metal reduction over an unmodified zeolite version since the Cu—Ni catalyst is able to oxidize stored HC and retain HC to a higher temperature.

### Example 2

Two of the H-beta-40 (H-BEA) zeolite traps of Example 1 (with and without Cu—Ni) were subjected to simulated biofuel-mix gasoline (40% ethanol/60% gasoline) emissions comprising a blend of inlet gases including acetaldehyde, ethanol, propylene, isopentane, and toluene. An inert feed (10% water in nitrogen) was used during temperature programmed desorption. Tables 1 and 2 illustrate the amounts of adsorbed and desorbed hydrocarbons for the two traps.

TABLE 1
H-Beta-40 Zeolite (400/14) without Cu—Ni catalyst

| | | | Adsorbed | | |
|---|---|---|---|---|---|
| | | HC | HC | Temp - 50% | Temp - 80% |
| | Inlet | Adsorbed | Desorbed | Desorbed | Desorbed |
| | Gas | (%) | (%) | (° C.) | (° C.) |
| Acetaldehyde | C₂H₄O | 93.6 +/− 0.4 | 49.1 +/− 24.8 | 193 +/− 34 | 272 +/− 2 |
| Ethanol | C₂H₅OH | 94.3 +/− 0.2 | 4.8 +/− 4.5 | 327 +/− 56 | 389 +/− 9 |
| Propylene | C₃H₆ | 92.5 +/− 0.4 | 38.3 +/− 2.4 | 276 +/− 16 | 400 +/− 28 |
| IsoPentane | C₅H₁₂ | 94.1 +/− 0.1 | 171.9 +/− 4.6 | 299 +/− 0 | 348 +/− 9 |
| Toluene | C₇H₈ | 94.5 +/− 0.4 | 103.2 +/− 4.2 | 363 +/− 12 | 406 +/− 7 |

Weighted Summary

| | |
|---|---|
| Adsorbed HC (%) = | 93.6 +/− 0.1 |

| | | | |
|---|---|---|---|
| Adsorbed HC leaving unconverted (%) = | 80.6 +/− 0.1 | 306 +/− 17 | 385 +/− 16 |
| Adsorbed HC leaving as Methylpropene (%) = | 3.9 +/− 0.3 | 378 +/− 7 | 453 +/− 19 |
| Adsorbed HC leaving as Cyclohexane (%) = | 0.9 +/− 0.1 | 380 +/− 16 | 478 +/− 99 |
| Adsorbed HC leaving as Ethane (%) = | 0.3 +/− 0.0 | 369 +/− 7 | 421 +/− 16 |
| Adsorbed HC leaving as Ethylene (%) = | 9.7 +/− 0.1 | 316 +/− 7 | 389 +/− 11 |
| Adsorbed HC leaving as CO₂ (%) = | 0.8 +/− 0.4 | 87 +/− 71 | 284 +/− 63 |

TABLE 2
H-Beta-40 (400/14) with 7 wt % Cu—Ni

| | | | Adsorbed | | |
|---|---|---|---|---|---|
| | | HC | HC | Temp - 50% | Temp - 80% |
| | Inlet | Adsorbed | Desorbed | Desorbed | Desorbed |
| | Gas | (%) | (%) | (° C.) | (° C.) |
| Acetaldehyde | C₂H₄O | 93.2 +/− 1.0 | 109.1 +/− 7.5 | 299 +/− 9 | 445 +/− 10 |
| Ethanol | C₂H₅OH | 94.3 +/− 0.6 | 3.0 +/− 4.0 | 384 +/− 9 | 437 +/− 5 |
| Propylene | C₃H₆ | 94.2 +/− 0.1 | 81.0 +/− 2.3 | 451 +/− 3 | 515 +/− 2 |
| IsoPentane | C₅H₁₂ | 94.3 +/− 0.1 | 102.7 +/− 5.5 | 267 +/− 4 | 307 +/− 6 |
| Toluene | C₇H₈ | 94.5 +/− 0.6 | 14.5 +/− 7.6 | 501 +/− 10 | 545 +/− 14 |

Weighted Summary

| | |
|---|---|
| Adsorbed HC (%) = | 94.3 +/− 0.3 |

| | | | |
|---|---|---|---|
| Adsorbed HC leaving unconverted (%) = | 61.3 +/− 1.2 | 409 +/− 4 | 462 +/− 1 |
| Adsorbed HC leaving as Benzene (%) = | 9.5 +/− 4.5 | 554 +/− 16 | 611 +/− 9 |
| Adsorbed HC leaving as Methane (%) = | 0.5 +/− 0.0 | 524 +/− 5 | 582 +/− 12 |
| Adsorbed HC leaving as Ethylene (%) = | 4.8 +/− 0.5 | 463 +/− 6 | 575 +/− 6 |
| Adsorbed HC leaving as CO₂ (%) = | 23.9 +/− 1.3 | 560 +/− 3 | 624 +/− 2 |

As can be seen, the HC trap without Cu—Ni converted the adsorbed ethanol into ethylene and the adsorbed propylene into isopentane, cyclohexane and methylpropene. Both monoliths showed efficient adsorption of the inlet emissions, but the hydrocarbon trap containing a Cu—Ni catalyst showed improved conversion as the adsorbed toluene, propylene, and ethanol were converted to benzene, ethylene and CO₂. In addition, the generation of CO₂ from the stored hydrocarbons was only 0.8% for the trap without Cu—Ni in comparison with 23.9% for the trap containing the Cu—Ni catalyst.

It was further noted that adsorbed (coked) propylene in both traps required a burnout of 600° C. for the zeolite trap without Cu—Ni, but only 550° C. for the combined zeolite trap/Cu—Ni catalyst. Thus, the combined trap/catalyst system lowers the temperature needed for coke oxidation.

While not wishing to be bound by theory, it can be inferred from the data that the adsorbed propylene retention above 200° C. in the trap without Cu—Ni occurs through oligomerization by Bronsted acid chemistry, as propylene was primarily released as other cracked oligomer products (i.e., isoptenane, cyclohexane, and methylpropene). However, with the addition of the Cu—Ni catalyst, the propylene retention occurs through chemisorption or C═C Pi-bonding with the base metal sites, as propylene in the trap was released above 200° C. only as propylene or oxidized CO₂. A similar chemisorption may also occur with toluene, as toluene cracking to benzene and methane was only observed with the addition of a Cu—Ni catalyst at temperatures above 500° C.

### Example 3

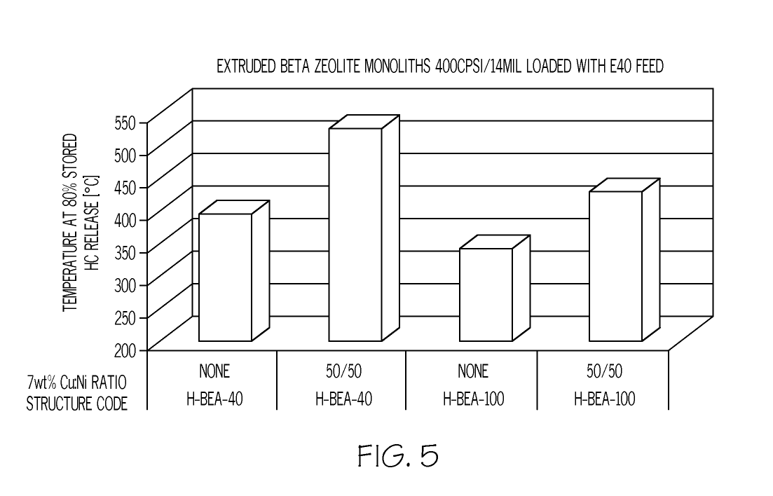

Four hydrocarbon traps were prepared in accordance with an embodiment of the invention. The first trap comprised an extruded zeolite monolith formed by extruding 80% by weight H-Beta-40 zeolite through an extruder at a cell density of 400 cpsi and a wall thickness of 14 mil. The second trap comprised the same H-beta-40 zeolite impregnated with 7 wt % of a Cu—Ni mixture (50/50 ratio). The third trap comprised an extruded zeolite monolith formed by extruding 80% by weight H-Beta-100 zeolite through an extruder at a cell density of 400 cpsi and a wall thickness of 14 mil. A fourth trap was formed comprising the same H-beta-100 zeolite, but was impregnated with 7 wt % of a Cu—Ni mixture (50/50 ratio). The traps were tested for stored hydrocarbon release. The results are shown in FIG. 5. As can be seen, higher stored HC desorption temperatures are obtained with H-beta-40 and H-beta-100 zeolite traps which contain a Cu—Ni catalyst. The trap comprising H-beta-40 zeolite exhibited the best desorption temperature. The results also suggest that the HC retention mechanisms are different based on the presence or absence of a Cu—Ni catalyst (i.e., Bronsted acid vs. chemisorption).

### Example 4

The hydrocarbon trap/Cu—Ni catalyst of Example 1 was subjected to high temperature aging conditions (a full-useful life aging process) in comparison with the extruded H-Beta-40 zeolite monolith of example 1 which did not contain the Cu—Ni catalyst. The aging conditions included acceleration at 150K miles for 50 hours, and utilized a pulse combustion reactor (pulsator) in four different modes:

1) stoichiometric combustion (λ=1)
2) Rich combustion (λ=0.92)
3) Rich combustion with addition of secondary air (λ=1.1)
4) stoichiometric combustion with secondary air (λ=1.3)

The sample temperature was maintained between 740° C. to 840° C. during aging to achieve an exponentially weighted effective temperature of 760° C. An inert feed (10% water in nitrogen) was used during temperature programmed desorption. Tables 3 and 4 illustrate the adsorption and desorption amounts for each of the traps.

TABLE 3
H-Beta-40 zeolite (without Cu—Ni catalyst) pulsator aged 760° C./50 h 4 mode

| | | | Adsorbed | | |
|---|---|---|---|---|---|
| | | HC | HC | Temp - 50% | Temp - 80% |
| | Inlet | Adsorbed | Desorbed | Desorbed | Desorbed |
| | Gas | (%) | (%) | (° C.) | (° C.) |
| Acetaldehyde | C₂H₄O | 93.8 +/− 0.2 | 80.0 +/− 21.5 | 149 +/− 2 | 247 +/− 33 |
| Ethanol | C₂H₅OH | 94.3 +/− 0.9 | 45.4 +/− 1.5 | 324 +/− 4 | 377 +/− 6 |
| Propylene | C₃H₆ | 87.1 +/− 2.8 | 43.0 +/− 1.8 | 40 +/− 0 | 293 +/− 87 |
| IsoPentane | C₅H₁₂ | 94.7 +/− 0.4 | 148.2 +/− 1.8 | 262 +/− 2 | 329 +/− 20 |
| Toluene | C₇H₈ | 94.7 +/− 0.2 | 100.4 +/− 5.7 | 315 +/− 7 | 369 +/− 1 |

Weighted Summary

| | |
|---|---|
| Adsorbed HC [%] = | 91.7 +/− 1.4 |

| | | | |
|---|---|---|---|
| Adsorbed HC leaving unconverted (%) = | 83.4 +/− 0.4 | 198 +/− 3 | 330 +/− 27 |
| Adsorbed HC leaving as 2-methylpropene (%) = | 5.0 +/− 0.1 | 368 +/− 7 | 460 +/− 13 |
| Adsorbed HC leaving as Cyclohexane (%) = | 1.1 +/− 0.1 | 374 +/− 7 | 414 +/− 1 |
| Adsorbed HC leaving as Ethylene (%) = | 5.4 +/− 0.0 | 351 +/− 5 | 421 +/− 7 |
| Adsorbed HC leaving as CO₂ (%) = | 2.0 +/− 0.3 | 596 +/− 22 | 619 +/− 19 |

TABLE 4
H-Beta-40 zeolite with 6 wt % (Cu + Ni) pulsator aged 760° C./50 h 4-mode

| | | HC | HC | Temp - 50% | Temp - 80% |
|---|---|---|---|---|---|
| | Inlet | Adsorbed | Desorbed | Desorbed | Desorbed |
| | Gas | (%) | (%) | (° C.) | (° C.) |
| Acetaldehyde | C₂H₄O | 93.2 +/− 1.2 | 224.7 +/− 33.1 | 395 +/− 5 | 477 +/− 4 |
| Ethanol | C₂H₅OH | 93.9 +/− 0.2 | 51.5 +/− 9.4 | 360 +/− 5 | 421 +/− 2 |
| Propylene | C₃H₆ | 90.5 +/− 0.5 | 100.6 +/− 3.0 | 311 +/− 21 | 430 +/− 20 |
| IsoPentane | C₅H₁₂ | 93.6 +/− 0.3 | 108.4 +/− 3.9 | 239 +/− 1 | 281 +/− 5 |
| Toluene | C₇H₈ | 93.7 +/− 0.4 | 40.1 +/− 13.9 | 405 +/− 36 | 492 +/− 8 |

Weighted Summary

| | |
|---|---|
| Adsorbed HC (%) = | 92.5 +/− 0.1 |

| | | | |
|---|---|---|---|
| Adsorbed HC leaving unconverted (%) = | 84.3 +/− 4.3 | 324 +/− 16 | 410 +/− 8 |
| Adsorbed HC leaving as Benzene (%) = | 5.4 +/− 2.1 | 542 +/− 70 | 636 +/− 23 |
| Adsorbed HC leaving as Methane (%) = | −0.1 +/− 0.0 | 183 +/− 52 | 288 +/− 51 |
| Adsorbed HC leaving as Ethylene (%) = | 3.0 +/− 0.7 | 448 +/− 10 | 536 +/− 16 |
| Adsorbed HC leaving as CO₂ (%) = | 7.6 +/− 1.0 | 604 +/− 8 | 655 +/− 11 |

As can be seen, the HC trap without Cu—Ni converted the adsorbed ethanol into ethylene and the adsorbed propylene into isopentane, cyclohexane and methylpropene. Also as can be seen, the combined hydrocarbon trap/Cu—Ni catalyst system adsorbed propylene, ethanol, and toluene more strongly than the trap without Cu—Ni. In addition, the Cu—Ni catalyst exhibited improved conversion of the adsorbed toluene and ethanol into benzene, ethylene and CO₂. For example, the generation of CO₂ from stored hydrocarbons was only 2.0% for the HO trap without Cu—Ni in comparison with 7.6% with the combined HO trap/Cu—Ni catalyst system.

Accordingly, the use of the combined HC trap/Cu—Ni catalyst system provides strong adsorption for improved HO retention over the use of zeolite hydrocarbon traps without a Cu—Ni catalyst, especially with regard to propylene, ethanol and toluene, even under high temperature aging conditions.

Both aged traps maintained their Bronsted acid chemistry (indicated by conversion from ethanol to ethylene or propylene to other HC species). This is usually not the case with HC trap monoliths with zeolite content below 4 g/in³ as there are fewer zeolite and active sites to begin with which are eliminated by this aging environment.

### Example 5

Hydrocarbon traps as described in Example 1 and comprised of extruded zeolite monoliths were formed from H-Beta zeolite containing 7 wt % Cu—Ni and having a cell density of 400 cpsi and a wall thickness of 14 mil. The traps were prepared with different ratios of copper and nickel and tested for stored hydrocarbon release and adsorbed HC conversion using a 5-HC blend of acetaldehyde, ethanol, propylene, isopentane, and toluene (E40 feed).

The samples were subjected to aging conditions as described in Example 3 (760° C./50 hours). The samples were pre-reduced in a CO/H₂ mix at 550° C., cooled to 30° C. in nitrogen, then loaded with a 5-HC blend (acetaldehyde, ethanol, propylene, isopentane, and toluene) using a 30-second pulse at 30° C. and 1 atm. pressure.

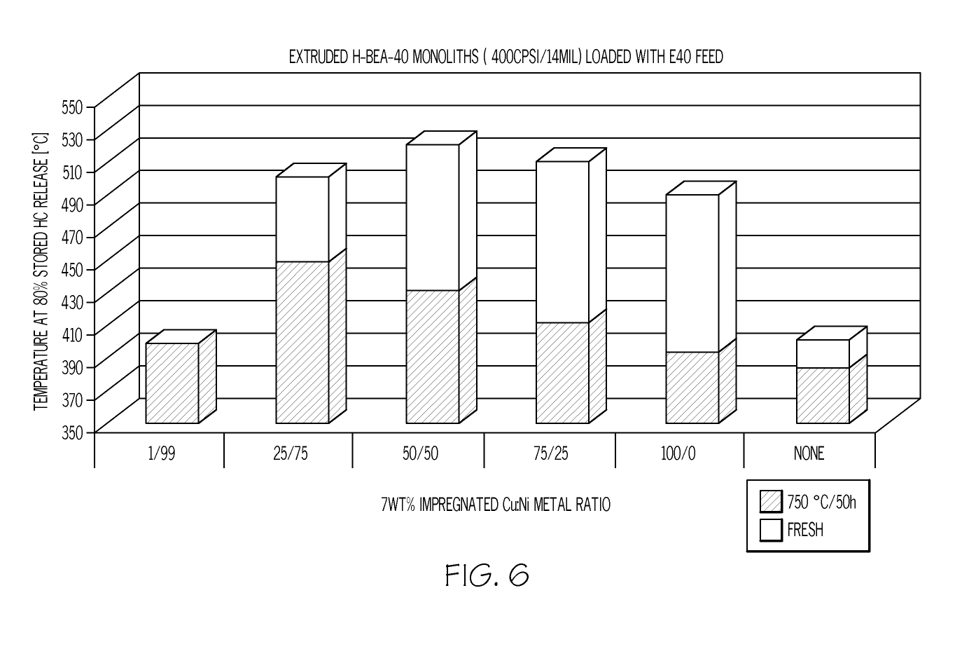

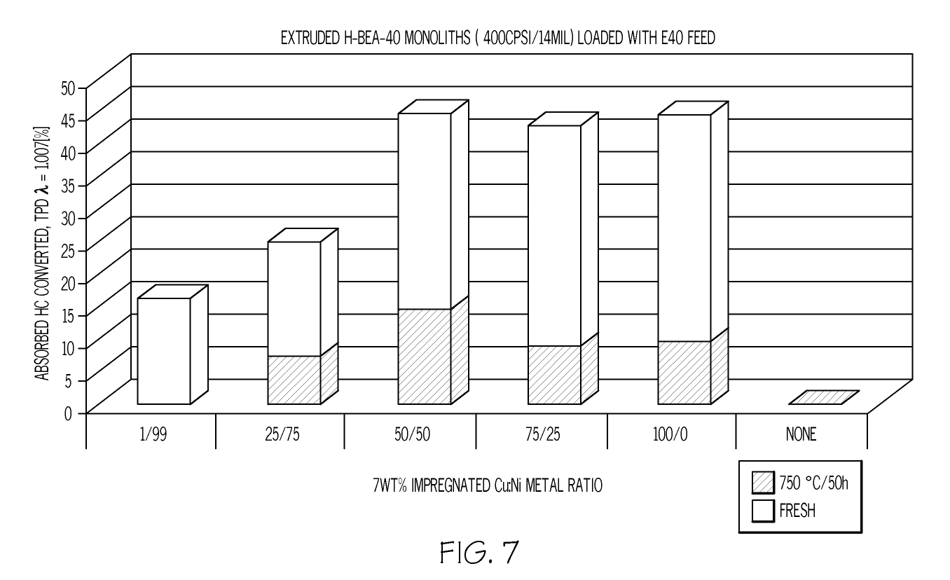

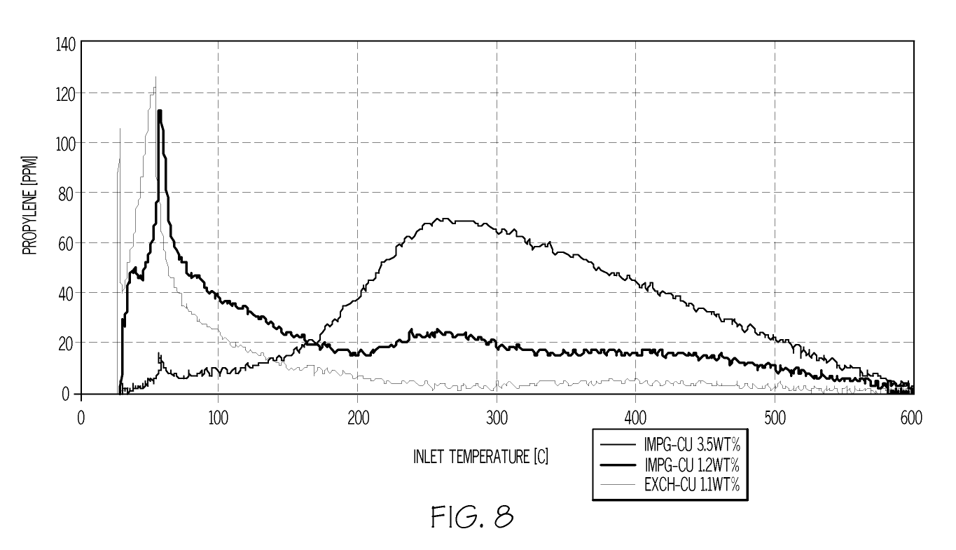

The results are shown in FIGS. 6 and 7. The results in FIG. 6 were obtained using an inert feed (10% water in nitrogen) during the temperature programmed desorption. The results in FIG. 7 were obtained using a stoichiometric feed during the temperature programmed desorption.

As can be seen, a 50:50 ratio of Cu:Ni provides the best overall combination of stored HC release and adsorbed HC conversion after aging.

### Example 6

The effect of copper metal loading on hydrocarbon desorption was tested using the following samples:

1) a Cu—Ni impregnated zeolite extruded monolith containing 3.5% Cu (and 3.5% Ni);
2) a catalyzed washcoated zeolite monolith containing 1.2 wt % Cu with the Cu—Ni mixture added to the zeolite washcoat prior to coating a three-way catalyst layer;
3) a copper ion-exchanged zeolite coated monolith containing 1.1 wt % Cu.

The samples were subjected to aging conditions as described in Example 3 (760° C./50 hours). The samples were pre-reduced in a CO/H₂ mix at 550° C., cooled to 30° C. in nitrogen, then loaded with a 5-HC blend (acetaldehyde, ethanol, propylene, isopentane, and toluene) using a 30-second pulse at 30° C. and 1 atm. pressure. An inert feed (10% water in nitrogen) was used during temperature programmed desorption. FIG. 8 illustrates the desorption of stored propylene for the samples (the figure illustrates the desorption with regard to propylene only as it strongly interacts with reduced copper). As can be seen, the samples containing less than 2 wt % Cu have large desorption peaks of propylene at 30° C. All samples showed a desorption peak at 50° C. and 400° C. The impregnated samples show a desorption peak at 250° C. that is not shown by the Cu ion-exchanged sample. The results show that the amounts of Ni and Cu in the 50/50 ratio should be between about 1% and 3.5% in order to prevent a desorption peak below 200° C. As can be seen, the impregnated sample with 3.5 wt % Cu has a unique desorption profile which moves most of the adsorbed propylene into a potential oxidation window above 200° C.

Having described the invention in detail and by reference to preferred embodiments thereof, it will be apparent that modifications and variations are possible without departing from the scope of the invention.

1. A combined hydrocarbon trap and catalyst system for reducing cold-start vehicle exhaust emissions comprising:
a monolithic substrate containing zeolite; and
a catalyst consisting of a mixture of copper and nickel impregnated in or washcoated on said substrate.

2. The combined hydrocarbon trap of claim 1 wherein said monolithic substrate comprises an extruded zeolite substrate.

3. The combined hydrocarbon trap of claim 1 wherein said monolithic substrate comprises a ceramic substrate washcoated with zeolite.

4. The combined hydrocarbon trap of claim 1 wherein said mixture comprises about 50% by weight copper and about 50% by weight nickel.

5. The combined hydrocarbon trap of claim 1 wherein said catalyst comprises about 1 to 20 wt % of the total weight of said monolithic substrate.

6. The combined hydrocarbon trap of claim 5 wherein said catalyst comprises from about 6 to 7 wt % of the total weight of said monolithic substrate.

7. The combined hydrocarbon trap of claim 1 wherein said zeolite has a Si/Al₂ ratio of about 20 to 100.

8. The combined hydrocarbon trap of claim 1 wherein said zeolite comprises beta-zeolite.

9. The combined hydrocarbon trap of claim 1 wherein said zeolite has a pore diameter of from about 4 to 8 Å.

10. The combined hydrocarbon trap of claim 1 wherein said zeolite comprises Fe ion-exchanged beta-zeolite.

11. A combined hydrocarbon trap and catalyst system for reducing cold-start vehicle exhaust emissions comprising:
a monolithic substrate containing zeolite; and
a catalyst comprising a mixture of copper and nickel impregnated in or washcoated on said substrate; and
a three-way catalyst selected from platinum, palladium, rhodium, and combinations thereof applied as a separate layer on said monolithic substrate.

12. The combined hydrocarbon trap of claim 11 wherein said three-way catalyst is included at a loading between about 0.1 and 3.0 g/in.

13. The combined hydrocarbon trap of claim 1 having a zeolite content of about 2 to 8 g/in³.

14. An exhaust treatment system comprising the combined hydrocarbon trap of claim 1 positioned in an exhaust passage of a vehicle.

15. A method for reducing cold start hydrocarbon emissions from a vehicle engine comprising:
providing a combined hydrocarbon trap and catalyst system positioned in an exhaust passage of a vehicle, said combined hydrocarbon trap comprising a monolithic zeolite substrate including a catalyst comprising a mixture of copper and nickel; and
passing exhaust gases through said trap.
